(19) United States
(12) Patent Application Publication
(10) Pub. No.: US 2023/0299954 A1
(43) Pub. Date: Sep. 21, 2023

(54) SECURE PROVISIONING OF COMMUNICATIONS CHANNELS

(71) Applicant: SAMSUNG ELECTRONICS CO., LTD., SUWON-SI (KR)

(72) Inventor: Mark Gorthorn RISON, CAMBRIDGE (GB)

(21) Appl. No.: 18/185,915

(22) Filed: Mar. 17, 2023

Related U.S. Application Data
(60) Provisional application No. 63/269,560, filed on Mar. 18, 2022.

(51) Int. Cl. H04L 9/08; H04L 9/32

(52) U.S. Cl. CPC H04L 9/0861; H04L 9/0841; H04L 9/3231

(57) ABSTRACT

A method for secure provisioning of a wireless communications channel includes a discovery phase and a provisioning phase, the discovery phase comprising: a first device: receiving a first local physical presence signal; a second device: receiving a second local physical presence signal; generating an asymmetric public-private key pair including a public key and a private key; scanning a plurality of channels by transmitting a request to be provisioned signal including the generated public key to receive a ready to provision signal; if the ready to provision signal was received over exactly one of the scanned plurality of channels, identifying the exactly one channel as the channel; the first device: receiving the request to be provisioned signal at least once; if the request to be provisioned signal was received with exactly one public key, proceeding to the provisioning phase; the provisioning phase comprising: one of the second device or the first device: allocating a secure link with the other of the second device or the first device based on the public key; the other of the second device or the first device: allocating the secure link from the one of the second device or the first device based on the public key; and provisioning the one of the second device or the first device.

### CROSS-REFERENCE

This application claims priority under 35 U.S.C. § 119 to U.S. Provisional Application No. 63/269,560 entitled SECURE PUSH BUTTON PROVISIONING and filed in the United States Patent and Trademark Office on Mar. 18, 2022, the disclosure of which is incorporated by reference in its entirety.

### FIELD

Embodiments of the present disclosure relate to communications technologies, and more particularly relate to secure provisioning of communications channels in communications systems.

### DISCUSSION

Secure provisioning of communications devices is balanced by ease of use, particularly for consumer segment devices. For example, Wi-Fi® Protected Setup™ (WPS) was introduced as a device provisioning protocol based on technology designed to ease the setup of security-enabled Wi-Fi® networks in home and small office environments. WPS supported a required first configuration method based on entering an 8-digit personal identification number (PIN), which was effectively implemented as a pair of separately confirmed 4-digit PINs, and an optional second configuration method based on pushing a button, to configure a network and enable security between a wireless client device (Station) and a wireless access point device (AP). WPS allowed a Station to be provisioned with security keys, and in devices additionally supporting the optional push-button configuration (PBC) method, could be initiated by push-button activations or the like on the Station or AP.

### SUMMARY

An embodiment for secure provisioning of a wireless communications channel includes: a discovery phase and a provisioning phase, the discovery phase comprising: a first device: receiving a first local physical presence signal; a second device: receiving a second local physical presence signal; generating an asymmetric public-private key pair including a public key and a private key; scanning a plurality of channels by transmitting a request to be provisioned signal including the generated public key to receive a ready to provision signal; if the ready to provision signal was received over exactly one of the scanned plurality of channels, identifying the exactly one channel as the channel; the first device: receiving the request to be provisioned signal at least once; if the request to be provisioned signal was received with exactly one public key, proceeding to the provisioning phase; the provisioning phase comprising: one of the second device or the first device: allocating a secure link with the other of the second device or the first device based on the public key; the other of the second device or the first device: allocating the secure link from the one of the second device or the first device based on the public key; and provisioning the one of the second device or the first device.

An embodiment for secure provisioning of a wireless communications channel at an access point includes: receiving a local physical presence signal; transmitting a ready to provision signal over the channel; receiving at least once a request to be provisioned signal including a generated public key; if the request to be provisioned signal was received with exactly one public key, allocating a secure link over the channel based on the public key; and transmitting over the channel provisioning information encrypted with the public key.

An embodiment for secure provisioning of a wireless communications channel at a station includes: receiving a local physical presence signal; generating an asymmetric public-private key pair including a public key and a private key; scanning a plurality of channels by transmitting a request to be provisioned signal including the generated public key to receive a ready to provision signal; if the ready to provision signal was received with no more than said another public key over exactly one of the scanned plurality of channels, identifying the exactly one channel as the channel; allocating a secure link over the channel based on the public key; receiving over the channel provisioning information encrypted with the public key.

### BRIEF DESCRIPTION OF THE DRAWINGS

Embodiments of the present disclosure may become more apparent and be better appreciated upon consideration of the following description of embodiments, which are offered as illustrative examples and not for purposes of limitation, when taken in conjunction with the accompanying drawings, in which:

FIG. 1 is a block diagram illustrating device provisioning roles in accordance with a wireless embodiment of the present disclosure;

FIG. 2 is a block diagram illustrating device provisioning roles in accordance with a wireless embodiment of the present disclosure;

FIG. 3 is a block diagram illustrating device provisioning roles in accordance with a wireless embodiment of the present disclosure;

FIG. 4 is a message flow diagram illustrating secure provisioning of a station in accordance with the embodiment of FIG. 1;

FIG. 5 is a message flow diagram illustrating secure provisioning of a station in accordance with the embodiment of FIG. 2; and

FIG. 6 is a message flow diagram illustrating secure provisioning of a station in accordance with the embodiment of FIG. 3.

### DETAILED DESCRIPTION

Embodiments of the present disclosure may use a push-button initiated public key exchange (PKEX), such as with a shared code between a station (STA) and an access point (AP) based on a string that may even be broadcast in the clear over a wireless communications medium, to authenticate the STA and the AP. For example, push-button provisioning may be authenticated using such a public key exchange. Although Wi-Fi® embodiments may be shown and described for illustrative purposes, it shall be understood that the teachings of the present disclosure are not limited to Wi-Fi®, and may be similarly adopted in many other modalities of communications, such as radio-frequency, optical, ultrasonic, and/or multi-access wired environments, without limitation.

In previous versions of Wi-Fi® Protected Setup™ (WPS), a necessarily supported personal identification number (PIN) method generally required a user to copy the PIN from either a sticker label or the web interface of the AP, and then enter this PIN into the Station and/or AP for PIN-based configuration. For the required PIN method, the use of an optional Registrar device was sometimes permitted to begin the registration and/or complete the configuration between a new Station and an active AP, particularly for a new Station and/or AP without a convenient bi-directional user interface (e.g., many IoT devices).

In some previous versions of WPS, an optionally supported push-button configuration (PBC) method generally required the user to push a button, whether actual or virtual, on both the AP and the new Station, to configure the connection. In some cases, the PBC button could have shared functionality, such as a power button on a wireless-capable printer, for example. Unfortunately, other unintended stations or devices could also not only join between button presses, and often up to two minutes after a button press, but could also further receive previously unknown wireless authentication credentials via extensible authentication protocol (EAP) or the like.

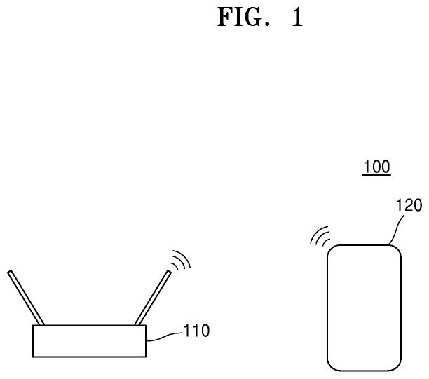

As shown in FIG. 1, a device provisioning system is indicated generally by the reference numeral 100. An access point (AP) 110 has a push-button or the like for secure provisioning, and communicates with a station (STA) 120 having a user interface in accordance with a wireless embodiment of the present disclosure. The access point 110 in this embodiment may be a wireless access point, router or gateway, without limitation thereto. The station 120 in this embodiment may be a wireless device having a convenient user interface, such as a smartphone or the like, without limitation thereto.

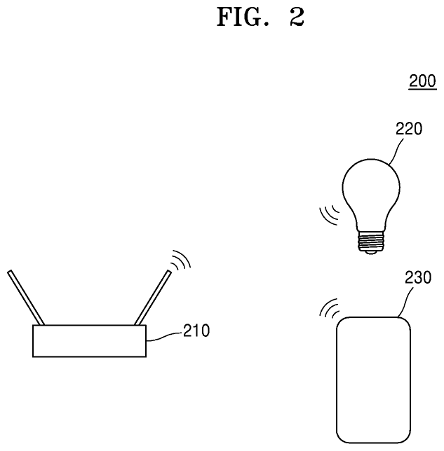

Turning to FIG. 2, a device provisioning system is indicated generally by the reference numeral 200. An access point 210 has a push-button or the like for secure provisioning, and communicates with a station 220 that lacks a convenient user interface by communicating with a registrar 230 that does have a user interface in accordance with a wireless embodiment of the present disclosure. The access point 210 in this embodiment may be a wireless access point, router or gateway, without limitation thereto. The station 220 in this embodiment may be a wireless Internet of Things (IoT) device that lacks a convenient user interface, such as a lightbulb or the like, without limitation thereto. The registrar in this embodiment may be a wireless device having a convenient user interface, such as a smartphone or the like, without limitation thereto.

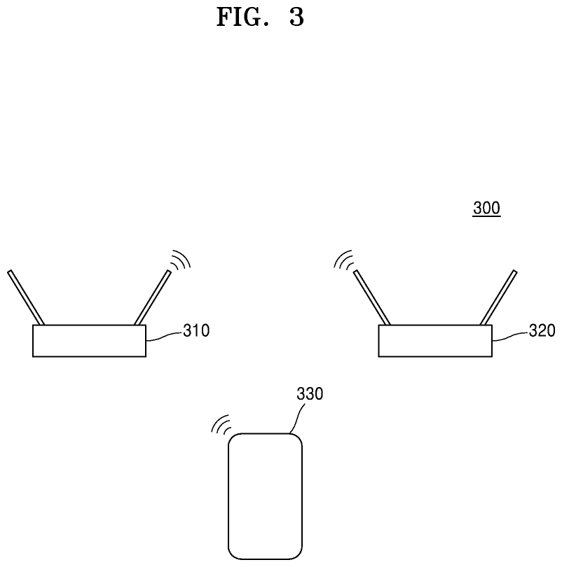

Turning now to FIG. 3, a device provisioning system is indicated generally by the reference numeral 300. An access point 310 has a push-button or the like for secure provisioning, and communicates with a station 320 that lacks a convenient user interface by communicating with a registrar 330 that does have a user interface in accordance with a wireless embodiment of the present disclosure. The access point 310 in this embodiment may be a wireless access point, router or gateway, without limitation thereto. The station 320 in this embodiment may be a wireless range extender or mesh device that lacks a convenient user interface, without limitation thereto. The registrar in this embodiment may be a wireless device having a convenient user interface, such as a smartphone or the like, without limitation thereto.

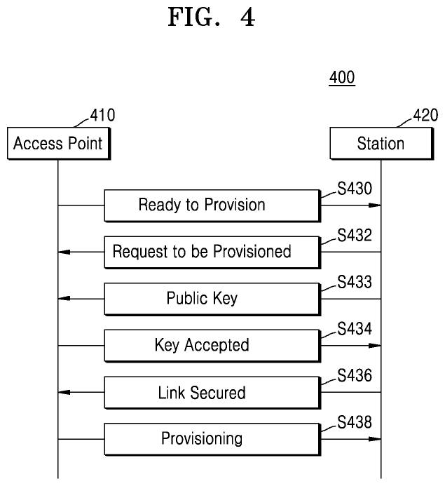

As shown in FIG. 4, a device provisioning method is indicated generally by the reference numeral 400. An access point 410 communicates with a station 420 via wireless messages. At step S430, the access point 410 optionally indicates to the station 420 that the access point is ready to provision the station. At step S432, the station indicates to the access point that the station requests to be provisioned, and provides its public key at step S433. It shall be understood that the steps S432 and S433 may be combined into one step and/or a single message.

At step S434, the access point indicates to the station that its public key has been accepted. At step S436, the station indicates to the access point that the station accepts that the link is secured. At step S438, the access point provisions the station, which indicates to the station that the access point accepts that the link is secured.

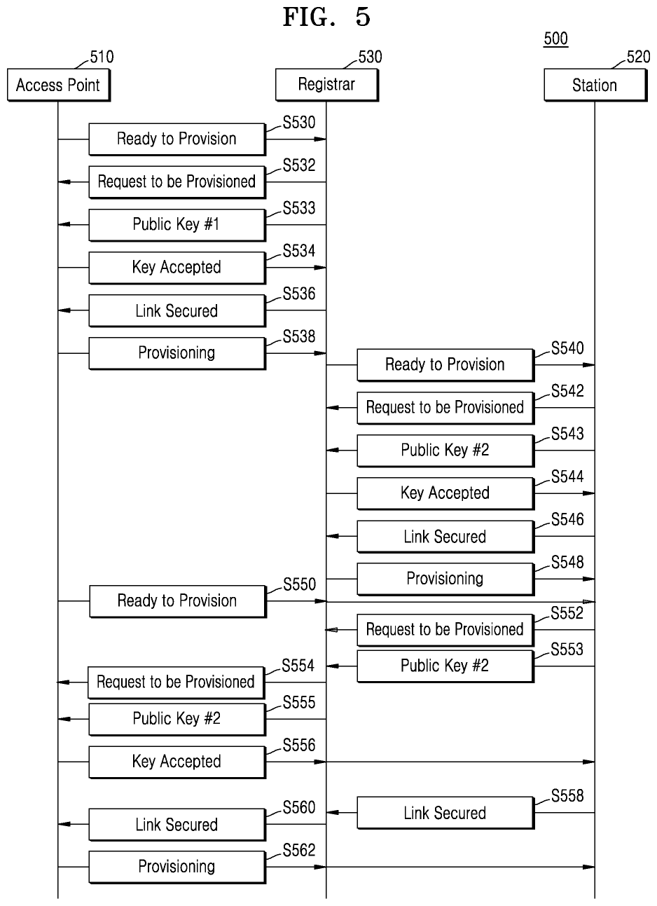

Turning to FIG. 5, a device provisioning method is indicated generally by the reference numeral 500. An access point 510 communicates with a station 520 via wireless messages interpreted by a registrar 530. Without limitation, the registrar device 530 may communicate with a station 520 that lacks its own dedicated push-button or the like, and an access point 510 that has its own push-button or the like, for device provisioning in accordance with an embodiment of the present disclosure.

The registrar 530 in this embodiment may be a personal computer, smartphone or the like capable of presenting a virtual push-button associated with the station 520, without limitation thereto. The station 520 may be an Internet-of-Things (IoT) device, such as a wireless enabled color-changing lightbulb that lacks a dedicated configuration push-button or the like, without limitation thereto.

The access point 510 communicates with the station 520 and the registrar 530 via wireless messages.

First, the access point provisions the registrar. At step S530, the access point 510 indicates to the registrar 530 that the access point is ready to provision the registrar. At step S532, the registrar indicates to the access point that the registrar requests to be provisioned, and provides its public key at step S533. It shall be understood that the steps S532 and S533 may be combined into one step and/or a single message. At step S534, the access point indicates to the registrar that its public key has been accepted. At step S536, the registrar indicates to the access point that the link is secured. At step S538, the access point provisions the registrar.

Next, the registrar provisions the station. At step S540, the registrar 530 indicates to the station 520 that the registrar is ready to provision the station. At step S542, the station indicates to the registrar that the station requests to be provisioned, and provides its public key at step S543. It shall be understood that the steps S542 and S543 may be combined into one step and/or a single message. At step S544, the registrar indicates to the station that its public key has been accepted. At step S546, the station indicates to the registrar that the link is secured. At step S548, the registrar provisions the station.

Then the access point provisions the station. At step S550, the access point 510 indicates to the registrar 530 and station 520 that the access point is ready to provision the station. At step S552, the station indicates to the registrar that the station requests to be provisioned, and provides its public key at step S553. It shall be understood that the steps S552 and S553 may be combined into one step and/or a single message. At step S554, the registrar indicates to the access point that the station requests to be provisioned, and provides the stations public key. At step S556, the access point indicates to the registrar and the station that the station's public key has been accepted. At step S558, the station indicates to the registrar that the link is secured. At step S560, the registrar indicates to the access point that the station's link has been secured. At step S562, the access point provisions the station.

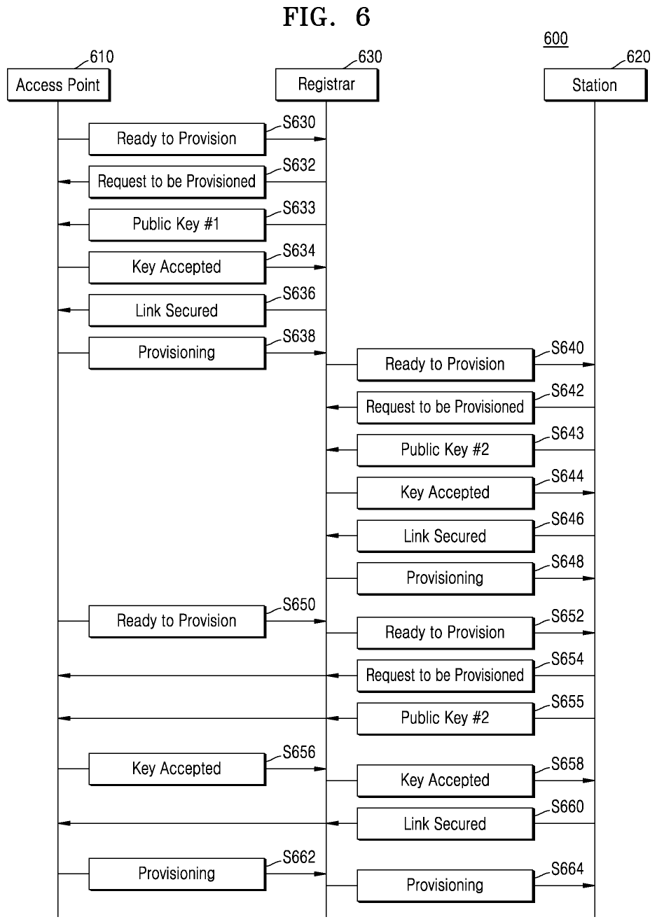

Turning now to FIG. 6, a device provisioning method is indicated generally by the reference numeral 600. An access point 610 communicates with a station 620 via wireless messages interpreted by a registrar 630. Without limitation, the registrar device 630 may communicate with a station 620 that lacks its own dedicated push-button or the like, and an access point 610 that has its own push-button or the like, for device provisioning in accordance with an embodiment of the present disclosure.

The registrar 630 in this embodiment may be a personal computer, smartphone or the like capable of presenting a virtual push-button associated with the station 620, without limitation thereto. The station 620 may be a range extender or mesh device, such as a wireless repeater or the like that lacks a dedicated configuration push-button, without limitation thereto. The access point 610 may have a dedicated configuration push-button, and may communicate with the station 620 and the registrar 630 entirely via wireless messages, or by hybrid means (e.g., wireless, wired, infrared or the like) without limitation thereto.

First, the access point provisions the registrar. At step S630, the access point 610 indicates to the registrar 630 that the access point is ready to provision the registrar. At step S632, the registrar indicates to the access point that the registrar requests to be provisioned, and provides its public key at step S633. It shall be understood that the steps S632 and S633 may be combined into one step and/or a single message. At step S634, the access point indicates to the registrar that its public key has been accepted. At step S636, the registrar indicates to the access point that the link is secured. At step S638, the access point provisions the registrar.

Next, the registrar provisions the station. At step S640, the registrar 630 indicates to the station 620 that the registrar is ready to provision the station. At step S642, the station indicates to the registrar that the station requests to be provisioned, and provides its public key at step S643. It shall be understood that the steps S642 and S5643 may be combined into one step and/or a single message. At step S644, the registrar indicates to the station that its public key has been accepted. At step S646, the station indicates to the registrar that the link is secured. At step S648, the registrar provisions the station.

Then the access point provisions the station. At step S650, the access point 610 indicates to the registrar 630 that the access point is ready to provision the station. At step S652, the registrar 630 indicates to the station 620 that the access point is ready to provision the station. At step S654, the station indicates to the registrar and the access point that the station requests to be provisioned, and provides its public key at step S655. It shall be understood that the steps S654 and S655 may be combined into one step and/or a single message. At step S656, the access point indicates to the registrar station that the station's public key has been accepted. At step S658, the registrar indicates to the station that the station's public key has been accepted by the access point. At step S660, the station indicates to the registrar and access point that the link is secured. At step S662, the access point sends provisioning information for the station to the registrar. At step S664, the registrar sends the provisioning information from the access point to the station, and the access point provisions the station.

Although the embodiment of FIG. 5 shows an optional registrar operating in a mode that is active in an upload direction and passive in a download direction, while the embodiment of FIG. 6 shows a registrar operating in a mode that is active in a download direction and passive in an upload direction, it shall be understood that the present disclosure is not limited to these illustrative examples. For example, in an alternate embodiment or environment, the registrar may operate in a mode that is active in both directions and/or alternates between modes in response to varying channel conditions or devices.

Secure provisioning of the access point (AP) and station (STA), even when an attacker is present, may proceed as set forth in the embodiment of Table 1, without limitation thereto.

TABLE 1

| | | | |
|---|---|---|---|
| | | | Attacker |
| Step | STA | AP | (informative notes) |

Discovery

| | | | |
|---|---|---|---|
| 1 | | User presses | Might detect AP |
| | | button on AP. | “ready to provision”. |
| | | AP indicates “ready to | |
| | | provision” in beacons | |
| | | and probe responses | |
| | | for a period of time | |
| | | sufficient for user to | |
| | | go to STA and press | |
| | | its button, and for | |
| | | thorough STA all- | |
| | | channel scan time. | |
| 2 | User presses | | Might detect STA |
| | button on STA. | | wants to provision. |
| | STA generates a | | Might pretend to be |
| | random Diffie-Hellman | | a STA wanting to |
| | (DH) private key or | | provision; might |
| | the like, and the | | even pretend to be |
| | corresponding DH | | the same STA |
| | public key or the like. | | (same TA and DH |
| | STA actively scans all | | public key). |
| | channels on which it is | | Might pretend to be |
| | allowed to probe to find | | a “ready to |
| | AP(s) indicating “ready | | provision” AP; |
| | to provision”. | | and/or attempt a |
| | The probe requests | | DoS attack if STA |
| | indicate “request to be | | still detects real AP. |
| | provisioned” and | | Might jam STA |
| | include STA’s | | probes or AP |
| | DH public key. | | responses, or at |
| | If STA doesn’t find | | least jam the |
| | exactly one such AP | | channel on which |
| | whether through probe | | the AP is operating. |
| | response or beacon | | |
| | (the latter is useful in | | |
| | case a probe response | | |
| | is missed because it is | | |
| | corrupted or STA is no | | |
| | longer on the channel), | | |
| | STA shall abort. | | |
| | Note that the same | | |
| | MAC address on | | |
| | different channels is | | |
| | considered a different | | |
| | device, unless | | |
| | specifically indicated | | |
| | otherwise. | | |
| 3 | | AP waits, while | Might pretend to be |
| | | indicating “ready to | a STA wanting to |
| | | provision”, for “request | provision; DoS if AP |
| | | to be provisioned” | still hears from real |
| | | probes. If AP | STA, or security |
| | | doesn’t get exactly | breach if AP doesn’t |
| | | one DH public key | hear from real STA. |
| | | among all the probes | |
| | | (irrespective of TA), | |
| | | AP shall abort. | |

Provisioning

| | | | |
|---|---|---|---|
| 4 | STA sets up a secure | AP accepts link setup | Might pretend to be |
| | link with AP, using | using the same DH | the same STA, but |
| | same DH public key, | public key previously | cannot complete DH |
| | and being prepared to | advertised by STA. | because would not |
| | wait for “ready to | AP may optionally allow | have STA DH |
| | provision” timer | link setup request for a | private key and |
| | on AP to expire. | short time after it stops | hence could not |
| | | indicating “ready to | compute the |
| | | provision” to improve | shared secret. |
| | | user experience if STA | |
| | | discovers AP just | |
| | | at the end of the | |
| | | readiness window, | |
| | | irrespective of TA. | |
| 5 | | AP securely | |
| | | provisions STA. | |

As outlined in Table 1, embodiments of the present disclosure may prevent a variety of attacks. The examples provided below outline examples of potential attacks as well as features that may prevent such attacks, without limitation thereto.

If a fake AP were enlisted in an attempt to get a STA provisioned by the fake AP instead of by the real AP, this attack would be prevented because the STA would see two “ready to provision” APs, even if they have the same MAC address on different channels, and abort. In an alternate embodiment, such as if the real AP is on a channel that the STA does not support, additional steps may be taken to confirm that the responding AP is the real AP. For example, if no STA is provisioned, the real AP may output an alert (e.g., red LED) rather than a confirmation (e.g., green LED). Moreover, the sharing of supported channel capabilities between the STA and the real AP may be used to mitigate such an attack. Moreover, this and other attacks may be mitigated or prevented in other embodiments by assuring that the real access point initiates the provisioning, and/or confirming that it successfully completes the provisioning.

If a fake STA were enlisted in an attempt to get the fake STA instead of a real STA provisioned by an AP, this attack would be prevented because the AP would see two “request to be provisioned” STAs with different public keys, even if they have the same MAC address on different channels, and abort. In an alternate embodiment, such as if the real STA is on a channel that the AP doesn't support, additional steps may be taken to confirm that the requesting STA is the real STA.

If a fake STA were enlisted in an attempt to masquerade as the real STA at the provisioning stage, this attack would be prevented because the AP requires the STA public key, such as a Diffie-Hellman (DH) public key, to be the same as in the discovery stage, and the fake STA would not have the corresponding STA DH private key, for example, so the link setup would fail.

In an alternate embodiment, the STA may send multiple probe request signals to reduce the possibility of failed receipt due to packet loss or the like. In general, increasing the number of signals increases the likelihood that these request signals reach the AP.

In an alternate embodiment, the AP may send multiple the probe response signals to reduce the possibility of failed receipt due to packet loss or the like. In general, increasing the number of signals increases the likelihood that these response signals reach the STA.

A “physical AP” device that has a single button controlling multiple APs (e.g., a multi-band AP) can advertise the list of centre frequencies on which its “ready to provision” APs operate. The STA treats all of these band APs in the same manner, “ready to provision” beacons or probe responses on different channels do not cause an abort as long as they all advertise exactly the same list of centre frequencies, and there is only one “ready to provision” response on any given channel. If the “physical AP” device does not get exactly one DH public key among all the probes, irrespective of transmitter address (TA) and AP/channel, all of its band APs shall abort (i.e., not accept a provisioning link setup on any).

In an alternate embodiment, this concept may be extended to an ESS consisting of multiple “physical AP” devices, in which the APs' MAC addresses would be advertised explicitly.

The embodiment of Table 1 might not prevent some other attacks, but these may be mitigated. The examples provided below outline a variety of potential attacks as well as features that may mitigate them, without limitation thereto.

If an attacker jams a real AP's channel and installs a fake AP on another channel such that the STA might see just the fake AP to be “provisioned” by this fake AP, while this is happening the attacker might get their fake STA provisioned by the real AP. But this can be mitigated by the STA declaring an alert (e.g., a red LED) if it cannot get probe requests onto a channel and/or detects lots of energy but no signal immediately following a probe request, and then the provisioning has to be triggered by the user pressing a “confirm” button on the AP, which the user would not press if the red LED were on at the STA. Similarly, an AP could refuse to provision if it cannot get beacons/probe responses out and/or there is lots of energy on the channel.

If an attacker puts a fake AP on the same channel and with the same MAC address as a real AP, the attack may be mitigated by consequent collisions (unless the fake AP manages to overwhelm the real AP's signal and cause the STA to only hear the fake AP).

Although the above-described illustrative embodiment uses a DH public key, it shall be understood that alternate embodiments may use any ad hoc public key exchange mechanism. That is, the key mechanism need not be limited to DH.

All actions correspond to actual user actions. In particular, there should not be any autonomous button pressing. Buttons may be physical or virtual (e.g., an icon to click on or touch). Moreover, diagnostic indications (e.g., when the AP or STA aborts, when the AP is ready to provision, when provisioning has succeeded or failed) may be provided to improve the user experience.

In operation, during a small window of opportunity, push-button bootstrapping might be subverted by an active attacker capable of receiving a wireless frame if the private key used by the station is not secret. But due to the nature of public key exchange, push-button bootstrapping is resistant to passive attack since even a passive attacker that knows the public key could not determine the private key, and hence could not compute the shared secret.

Unlike a public key exchange method alone, push-button provisioning with reuse of a shared public key by a station or registrar does not open up any additional attacks. This strength is because the public key used is already public, but subsequent exchanges require possession of private keys as well as knowledge of the public keys.

In an embodiment, the user should press the button on the most secure device (e.g., access point rather than station) first. For example, if a user presses a button on the station to be enrolled first, a rogue access point or registrar might start provisioning immediately by replying with a ready to provision message. After the reception of this message, the station might send or resend a request to be provisioned message with its Public Key. It could then wait for the Key Accepted message, after which it would secure the link and await provisioning. Thus, the station might be configured by the rogue access point or registrar within seconds if the rogue access point or registrar adheres to a typical protocol, or even faster if it replies immediately to the station's request to be provisioned message and Public Key.

While exemplary embodiments may operate in Wi-Fi® and/or Bluetooth® environments, the present disclosure is not limited thereto. For example, alternate embodiments of the present disclosure may be configured to operate over any type of wireless communications medium and/or with other wireless communications protocols, channels or environments.

Although exemplary embodiments of the present disclosure have been shown and described, it shall be understood that those of ordinary skill in the pertinent art may make changes therein without departing from the scope, principles, and spirit of the present disclosure as defined by the appended claims and their equivalents.

What is claimed is:

1. A method for secure provisioning of a wireless communications channel, the method comprising a discovery phase and a provisioning phase, the discovery phase comprising:
a first device:
receiving a first local physical presence signal;
a second device:
receiving a second local physical presence signal;
generating an asymmetric public-private key pair including a public key and a private key;
scanning a plurality of channels by transmitting a request to be provisioned signal including the generated public key to receive a ready to provision signal;
if the ready to provision signal was received over exactly one of the scanned plurality of channels, identifying the exactly one channel as the channel;
the first device:
receiving the request to be provisioned signal at least once;
if the request to be provisioned signal was received with exactly one public key, proceeding to the provisioning phase;
the provisioning phase comprising:
one of the second device or the first device:
allocating a secure link with the other of the second device or the first device based on the public key;
the other of the second device or the first device:
allocating the secure link from the one of the second device or the first device based on the public key; and
provisioning the one of the second device or the first device.

2. The method of claim 1, further comprising:
the first device transmitting the ready to provision signal over the channel.

3. The method of claim 1, wherein the first local physical presence signal and the second local physical presence signal are indicative of a same user's presence at each of the first device and the second device, respectively.

4. The method of claim 1, wherein the first local physical presence signal and the second local physical presence signal comprise biometric identification information of the user.

5. The method of claim 1, wherein the first device transmits the ready to provision signal in beacons and probe responses for a period of time.

6. The method of claim 5, wherein the period of time is sufficient for a user to travel from the first device to the second device.

7. The method of claim 5, wherein the period of time is user selectable.

8. The method of claim 1, wherein a cryptographic algorithm for generating the public-private key pair is a Diffie-Hellman (DH) algorithm.

9. A method for secure provisioning of a wireless communications channel at an access point, the method comprising
receiving a local physical presence signal;
transmitting a ready to provision signal over the channel;
receiving at least once a request to be provisioned signal including a generated public key;
if the request to be provisioned signal was received with exactly one public key, allocating a secure link over the channel based on the public key; and
transmitting over the channel provisioning information encrypted with the public key.

10. The method of claim 9 wherein:
transmitting a ready to provision signal includes transmitting a public key of the access point;
the access point comprises a multi-channel access point, the method further comprising:
advertising a list of center frequencies on which the multi-channel access point is ready to provision.

11. The method of claim 10 wherein the multi-channel access point has a plurality of media access control (MAC) addresses corresponding to the plurality of channels, the method further comprising:
advertising a list of MAC addresses corresponding to the list of center frequencies, respectively.

12. The method of claim 9, further comprising:
refusing to provision if the access point cannot get beacons or probe responses out over the channel or if there is more than a threshold amount of energy on the channel.

13. The method of claim 9, wherein the local physical presence signal is generated in response to a press or touch of a at least one of a physical button or a virtual button or screen icon.

14. The method of claim 9, further comprising:
providing a diagnostic indication that the access point is ready to provision, or when provisioning has aborted, failed, or succeeded,
wherein the diagnostic indication is local at the access point.

15. The method of claim 14, wherein the provided diagnostic indication is local to the access point.

16. A method for secure provisioning of a wireless communications channel at a station, the method comprising:
receiving a local physical presence signal;
generating an asymmetric public-private key pair including a public key and a private key;
scanning a plurality of channels by transmitting a request to be provisioned signal including the generated public key to receive a ready to provision signal;
if the ready to provision signal was received with no more than said another public key over exactly one of the scanned plurality of channels, identifying the exactly one channel as the channel;
allocating a secure link over the channel based on the public key;
receiving over the channel provisioning information encrypted with the public key.

17. The method of claim 16, further comprising:
sending a plurality of probe request signals.

18. The method of claim 16, further comprising:
if the station cannot get probe requests onto a channel or detects energy greater than a threshold but no signal immediately following a probe request, signaling an alert;
providing a local diagnostic indication when provisioning has aborted, failed, or succeeded.

19. The method of claim 16,
wherein the ready to provision signal includes another public key,
wherein at least one of any ad hoc public key exchange mechanism or a Diffie-Hellman (DH) algorithm may be used.

20. The method of claim 16, wherein the local physical presence signal is responsive to a button comprising at least one of a physical button, a virtual button or a touch-screen icon.
